(19) United States
(12) Patent Application Publication
(10) Pub. No.: US 2016/0016181 A1
(43) Pub. Date: Jan. 21, 2016

(54) BEAN ROASTER WITH CONTROLLABLE FLUID LOFT AND ELECTROSTATIC COLLECTOR

(71) Applicants: KENNETH D LATHROP, LIBERTY LAKE, WA (US); SHAWN GANTS, LIBERTY LAKE, WA (US)

(72) Inventors: KENNETH D LATHROP, LIBERTY LAKE, WA (US); SHAWN GANTS, LIBERTY LAKE, WA (US)

(21) Appl. No.: 14/703,774

(22) Filed: May 4, 2015

Related U.S. Application Data
(60) Provisional application No. 61/988,143, filed on May 2, 2014.

(51) Int. Cl. B03C 3/36; A23N 12/12; A23N 12/08

(52) U.S. Cl. CPC B03C 3/36; A23N 12/08; A23N 12/12

(57) ABSTRACT

A bean roaster with controllable fluid loft and electrostatic collector is provided. An example system reduces large industrial features into a smaller roaster, without sacrificing roast flavor. A user can select custom airflow parameters to establish a bean loft mode and fluid loft pattern for a particular roast. Airflow parameters, including air volume and pressure may be user-selected along a continuum. Selected airflow interacts with a cyclonic diffuser to create airflow streams in the roast hopper, which in turn interact with the geometry of the roast hopper itself and the beans, including their size, mass, number, and streamline properties, to create a fluid loft pattern, such as helical pattern or spray pattern. An electrostatic collector applies static charge to chaff and smoke particulates enabling these to be secured within a small machine footprint. The condensed features provide a bean roaster that can use ordinary electrical hookup and common residential venting.

### BACKGROUND

Roasters for coffee and cocoa beans are often designed for large bulk batches. The large batches justify the size and cost of large conventional industrial-grade processors, which provide a quality roast flavor. The bulky industrial-grade apparatuses may include roasting drums and sizeable chaff collection systems. Attempts to make a bean roaster in a smaller package suitable for operation in a residence or smaller coffee shop business have resulted in inferior roasting quality, cumbersome venturi chaff collectors, and batches that are limited to a certain prescribed size (often too large for a home and too small for a business).

During the coffee roasting process the beans of coffee or cocoa double in size shedding their outer chaff skin. Coffee chaff, for example, is similar to the skin of a Spanish peanut. Thus, one pound of uncooked green beans sheds approximately three ounces of chaff during the roasting process. Since chaff is a light papery material that burns easily, it is preferable to extract the chaff before the chaff burns in the roast chamber.

There are several methods of extracting chaff. In a drum roaster the chaff falls through a perforated roast drum and is blown into a venturi cyclone. Fluid bed roasters either let the chaff burn in the roast chamber or use suction to direct the chaff into a venturi cyclone for removal. Cyclones for chaff removal require a lot of space and the chaff has a tendency to escape the cyclone, necessitating an afterburner before venting the roaster exhaust to the atmosphere.

These conventional roasters and chaff extraction systems are difficult to install and cannot provide a roaster machine capable of a quality roast that fits in a small space and uses a typical electrical hook-up and common low-temperature venting techniques.

### BRIEF DESCRIPTION OF THE DRAWINGS

The detailed description is set forth with reference to the accompanying figures. In the figures, the left-most digit(s) of a reference number identifies the figure in which the reference number first appears. The same numbers are used throughout the figures to reference like features and components.

For this discussion, the devices and systems illustrated in the figures are shown as having a multiplicity of components. Various implementations of devices and systems, as described herein, may include fewer components and remain within the scope of the disclosure. Alternately, other implementations of devices and systems may include additional components, or various combinations of the described components, and remain within the scope of the disclosure.

FIG. 1 is a diagram of an example bean roaster with controllable fluid loft and electrostatic collector.

FIG. 2 is a side view diagram of the example bean roaster with controllable fluid loft and electrostatic collector.

FIG. 3 is a diagram of an example heated airflow generator of the example bean roaster.

FIG. 4 is a diagram of an example cyclonic diffuser of the example bean roaster.

FIG. 5 is a diagram of another example of the cyclonic diffuser of the example bean roaster.

FIG. 6 is a diagram of example fluid loft patterns associated with different bean loft modes.

FIG. 7 is a diagram of an example electrostatic collector component of the example bean roaster.

FIG. 8 is a diagram of an example control panel of the example bean roaster.

FIG. 9 is a diagram of another example control panel of the example bean roaster.

FIG. 10 is a flow diagram of an example method of roasting beans.

### DETAILED DESCRIPTION

Overview

This disclosure describes a bean roaster with controllable fluid loft and electrostatic collector. An example system miniaturizes several aspects of large roast coffee production, without sacrificing the quality of roast provided by a conventional large roasting operation. For example, a bean roaster as described herein may offer enhanced airflow control for fluid bed roasting, and customization of the fluid bed in relation to an amount of beans to be roasted. An example chaff collection system shortens the airflow path for cooling chaff and smoke particulates before collecting these for elimination, and then captures the chaff and smoke particulates compactly by electrostatic means or with static assistance.

An entire bean roasting system provides a custom-controllable quality roast for a range of batch sizes, from a few ounces of beans to nearly ten pounds of beans, yet can fit within a relatively small footprint of floor space and use common electrical and venting hook-ups, as available in most households or small businesses.

Example Systems

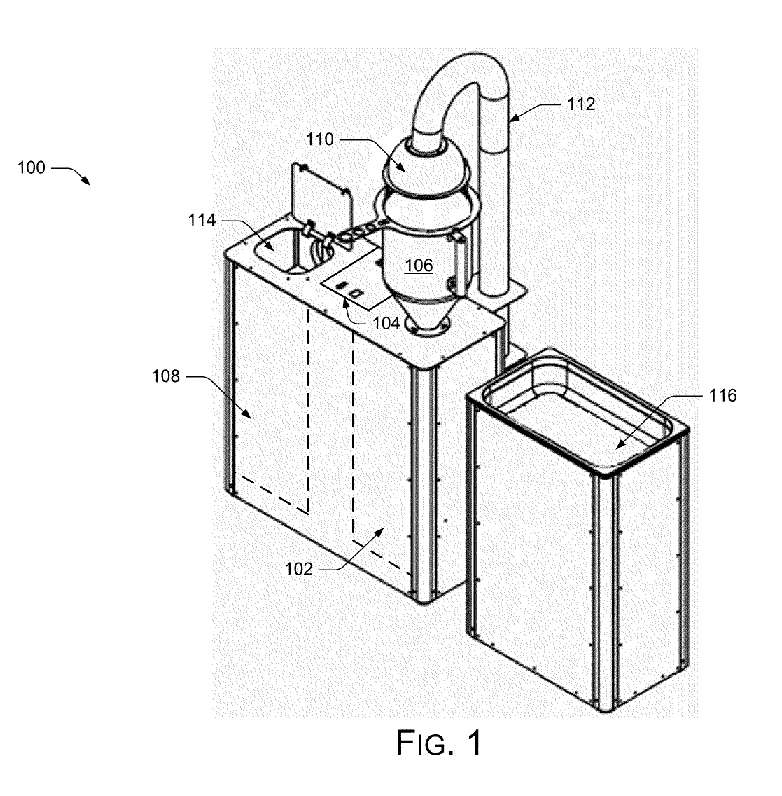

FIG. 1 shows an example system. In an implementation, an example bean roaster 100 possesses several components, features, and assemblies that work together in a compact roasting system 100.

In an implementation, a heated airflow generator 102 creates heated air, the “fluid” of the fluid-bed roaster, at fully-controllable volumes, pressures, and temperatures. The volume, pressure, and temperature of the heated airflow are user-selectable via one or more controllers accessible by knob, dial, switch, icon, etc., on a user interface, such as a control panel 104, for example. The heated airflow is forced into a hopper 106, such as a perforated-bottom roast hopper 106, which is the chamber in which the beans are roasted.

The beans to be roasted can be coffee beans, cocoa beans, or other types of beans, seeds, and nuts that are conventionally cooked or roasted. The controls extended to the user in the control panel 104 can allow the user to customize the roasting parameters, and also the characteristics of the fluid bed, such as flow shape, air trajectory, lofted bean trajectories, and so forth. In an implementation, the controls enable the user to select various loft modes that roll or spin the beans to expose the beans to the roasting heat in various ways, extend airborne loft paths, peel off the chaff and remove smoke and volatiles in various ways, and stir the beans in beneficial patterns. The loft modes can be custom created by the interaction of airflow force, direction, and volume with the particular cylindrical geometry of the hopper 106.

A chaff collection system 108 that includes a vacuum assembly, begins at a hood 110, which vacuums chaff and smoke particulates from the hopper 106, and also adds-in ambient air from around the top of the hopper 106, both for airflow volume and for fast cooling of the chaff, smoke, gases, and excess roasting air (the heated airflow) arising from the hopper 106 and created by the heated airflow generator 102. The inflow of ambient air also assists in capture of escaping chaff and excess aromas, which would otherwise leave the vicinity of the hopper 106.

The chaff and smoke particulates captured at the hood 110 travel up and then down a flue 112 (chute) and further into an electrostatic collector 114 of the chaff collection system 108.

In one scenario, a cooling tray 116 is embodied in a separate module that may be positioned as desired with respect to the main machine. The cooling tray 116 may also be connected to a vacuum, e.g., the vacuum assembly 202 of the chaff collection system 108. The cooling tray 116 may have a capacity for spreading a relatively large batch of hot beans in a thin layer, and then drawing ambient air through the layer of hot beans by vacuum, for rapid cooling.

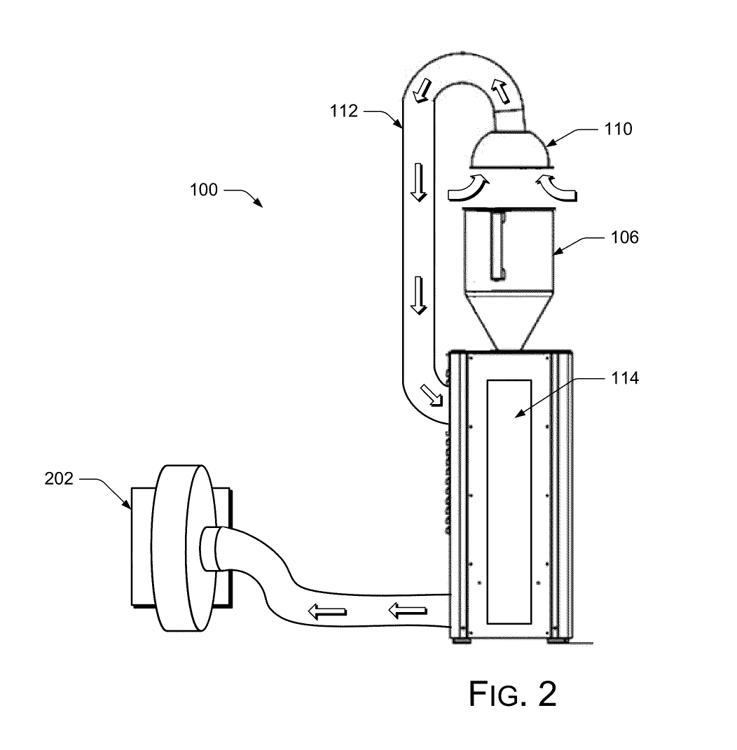

FIG. 2 shows a side view of the example bean roaster 100. The flue 112 deposits chaff, smoke particulates, and hot gases into an electrostatic collector compartment 114 of the example bean roaster 100. Vacuum airflow may be created by vacuum assembly 202, or other vacuum source. The vacuum assembly 202 may employ a suction blower of approximately 500 to 1000 cubic feet per minute (CFM). The vacuum assembly 202 can be connected to the example bean roaster 100 by standard vent hosing, such as four-inch dryer hose, and may be located remotely from the example bean roaster 100 to reduce or eliminate noise and facilitate remote elimination of the chaff, smoke, and gases that are being discarded.

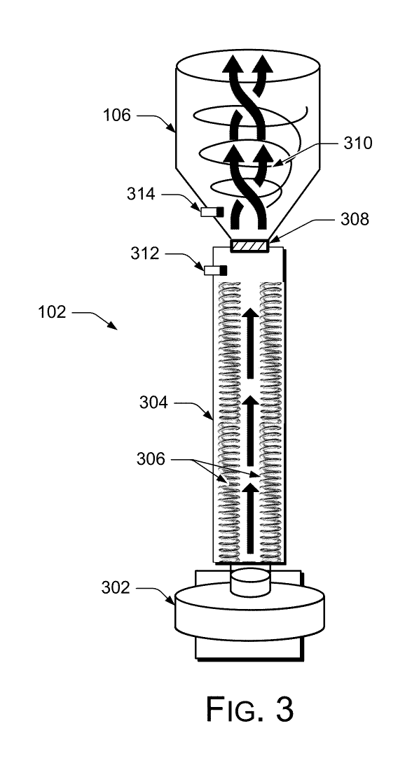

FIG. 3 shows the example heated airflow generator 102 of FIG. 1, in greater detail. A blower 302 or other controllable air source is disposed at the bottom of a heated airflow stack. The blower 302 preferably creates a relatively low pressure and high volume airflow, for lofting the beans to be roasted, although the air pressure and air volume are fully adjustable. In an implementation, the airflow is approximately 160 cubic feet per minute (CFM) volume at a pressure of approximately 110 Torr. For improved operation, a known beneficial roast-air-to-ambient-air mixture can be built into the example bean roaster 100. An air heating chamber 304 receives the forced air from the blower 302, and contains one or more heat sources, such as heating elements 306. In an implementation, the heating elements 306 are dual, electric 5200 watt linear (but coiled) elements, capable of converting 10,400 watts of electricity to heat. In an implementation, two heating elements 306 anywhere in the range of 4500-5500 watts each may be used in the air heating chamber 304.

The heating elements 306 are current-controlled or voltage-controlled, or both, to provide a continuum of power settings between zero watts and the maximum available, such as 11,000 watts when two 5,500 watt elements are used. Or, more practically, the minimum heat to be applied may start around 1100 watts. The elements may be nickel-chromium wire (nichrome) or other resistive material. The controller may consist of or include solid-state thyristor, silicon-controlled rectifier (SCR), triac, pulse-width modulation (PWM), or solid-state relay technologies. Preferably, the heating elements 306 are solid-state controlled with a potentiometer for user fine-control. A variable transformer or rheostat may also be used, but a digital controller or an industrial process temperature controller is preferred. One or more thermostats may also be worked into the control circuit to hold a desired temperature. Likewise, other feedback mechanisms may be worked into the control circuit for automatic control, especially as the roasting beans change their temperature and their mass as they lose chaff and volatile oils.

A diffuser 308 receives the heated airflow from the air heating chamber 304. In an implementation, the diffuser 308 has blades or other geometry to direct the heated airflow in useful flow streams or patterns 310, to customize the fluid bed and thereby the trajectories of the lofted beans during a roast. This allows the user to have a custom hand in maintaining a high quality of the roasted product. Electronic thermometers 312 & 314 may be situated at various places with respect to the heated airflow and the hopper 106 in order to track each roast. For example, a first thermometer 312 may be placed upstream of the diffuser to monitor the heated airflow as it leaves the heating elements 306, and a second thermometer 314 may be placed in the hopper 106 near the base of the fluid bed, to discern the actual temperature of the lofted-bean-heated-airflow mix.

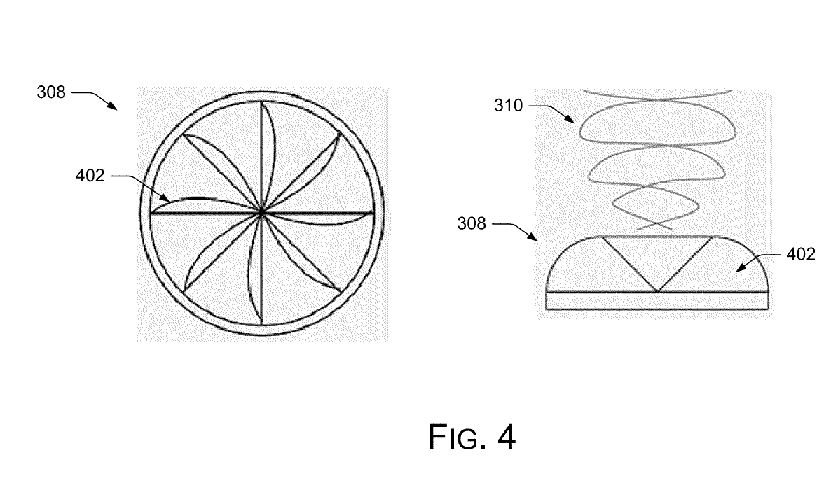

FIG. 4 shows an example configuration of the diffuser 308. The diffuser 308 may have vanes or blades 402 to redirect the heated airflow received from the air heating chamber 304. The blades 402 may be shaped and directed to create different airflow streams and patterns 310, depending on the characteristics of the airflow arriving at the diffuser 308. For example, the diffuser 308, when interacting with the heated airflow of a certain pressure and velocity, may create a helical fluid loft. Or, the diffuser 308 and heated airflow may form spray type fluid loft shape. The diffuser 308 may also direct the airflow to control an amount of centrifugal force applied to the lofted beans by the heated airflow.

In an implementation, the pitch of the blades 402 of the diffuser 308 can be varied by user-control. For example, the pitch may be varied from mere slit openings at an angle of approximately 10 degrees from the horizontal, to full-open. Variable diffuser blade pitch may be controlled by a dedicated user control (e.g., 906). A variable pitch diffuser 308 may have blades 402 controlled by a (e.g., gear) mechanism implemented through the central axis of the diffuser 308. An adjustable iris or an iris diaphragm mechanism may be modified to construct a diffuser 308 with variable pitch blades 402. The optional variable control of the diffuser blade pitch assumes that the air heating chamber 304 that is in service is also constructed to handle a reduction in heated airflow (e.g., by applying a bypass) when the diffuser 308 is in a state that constricts the airflow.

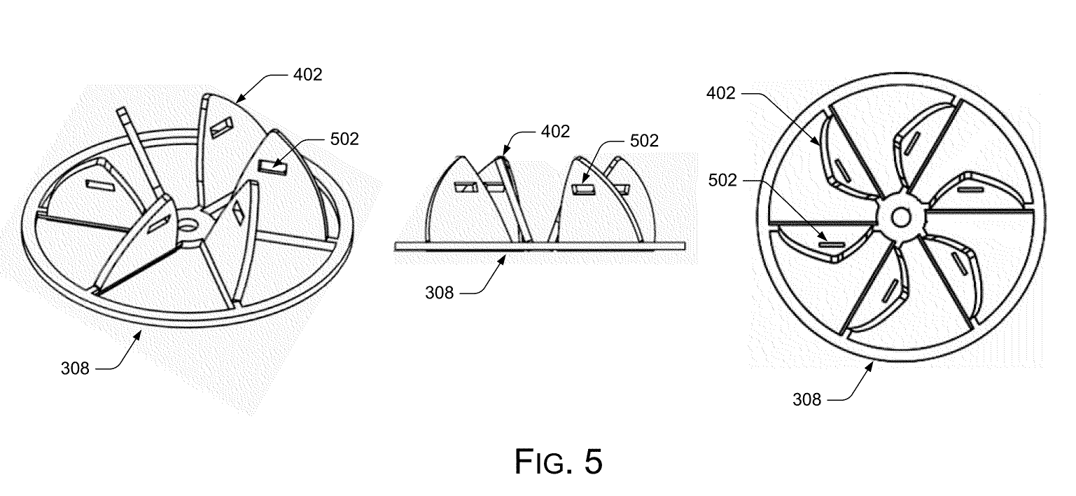

FIG. 5 shows another example implementation of the diffuser 308. In this embodiment, the example diffuser 308 consists of multiple blades 402, and each blade has an airstream taper, with sides mounting up in slanted streamline to a top point. Each blade 402 is disposed at a fixed pitch in relation to an axial flow of the heated airflow entering the diffuser 308. In an implementation, each blade 402 is disposed at a 37 degree pitch in relation to an axial flow of the heated airflow entering the diffuser 308, i.e., in relation to the vertical.

The example diffuser 308 in FIG. 5 may also have an axial diffusion slot 502 in each blade to pass a portion of the heated airstream more axially though each blade 402 in relation to a main helical airflow being directed by the greater surface of each blade 402. At some airflow velocities, the axial diffusion slots 502 create more useful turbulence for initially lofting the beans and for rolling and stirring the beans in the heated airflow. Variations of the axial diffusion slots 502 can be used to enable the user to achieve more complex and interesting airflow streams and loft patterns within the fluid bed. At low airflow velocities, the axial diffusion slots 502 can keep the beans from getting lodged in the diffuser 308.

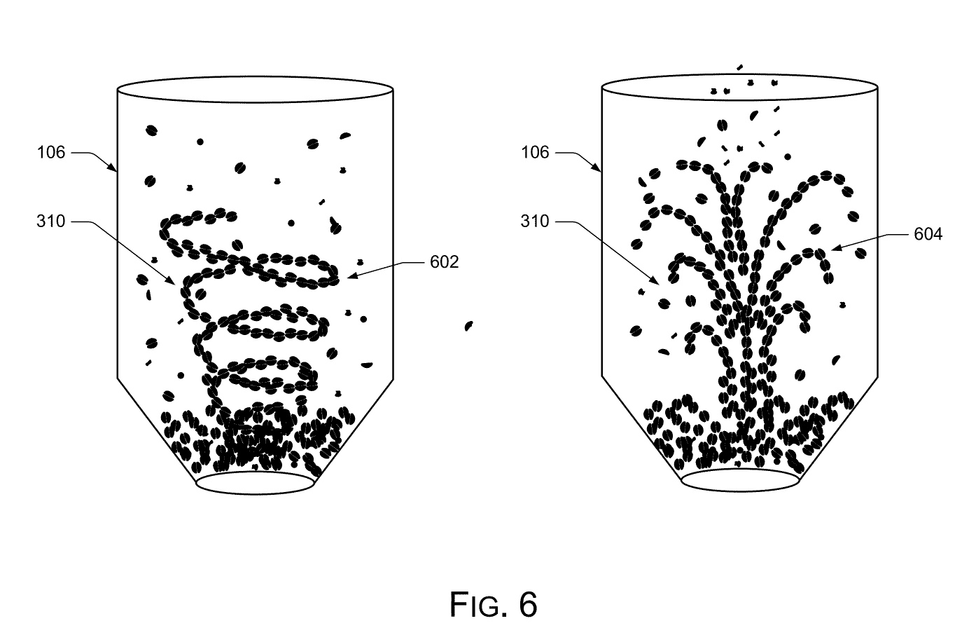

FIG. 6 shows example bean loft modes, achievable by user control of airflow through the diffuser 308. In some implementations, bean loft modes can be achieve by separate user control of airflow volume, airflow pressure, and diffuser blade pitch, for example, as these interact with the cylindrical geometry of the hopper 106, and also in reliance on the size, mass, shape, and quantity of the beans being roasted.

The user-adjustable parameters just described may be selected to produce a helical bean loft 602, in which the airflow paths and lofted bean trajectories tend to swarm the lofted beans in one or more helical patterns (the pattern of helical bean loft 602 illustrated in FIG. 6 is exaggerated or simplified for clarity to illustrate the point). A helical bean loft 602 and associated bean loft mode has practical advantages besides being visually entertaining or satisfying. The helical bean trajectories 602 may roll and stir the beans to a greater degree in the heat of the fluid bed, and provide longer airborne paths in a smaller hopper volume for purposes of miniaturizing the example bean roaster 100. A helical bean trajectory 602 also aids in peeling off and easy removal of chaff pieces from the beans, as compared with a conventional introduction of straight-on air into the hopper 106.

A helical bean loft 602 can also be used to impart more centrifugal force to the lofted beans to drive them to a greater radius in the hopper 106, where a laminar flow of the diffused heated air may be traveling with greater velocity near the inside surface of the hopper sidewall, than near the central axis of the hopper 106. This can apply vigorous stirring to the beans, which results in better mixing and a more even roast.

Referring again to FIG. 6, in another bean loft mode, the air volume, air pressure, and optionally, the diffuser blade pitch may be adjusted to achieve a fountain spray bean loft 604. The fountain spray bean loft 604 has the advantage of recycling the lofted beans vertically, so that the same beans are not trapped at the bottom of the fluid bed where it may be the hottest. The fountain spray bean loft 604 also provides the advantage of sending up chaff and smoke particulates axially in a central column, where the hood 110 of the chaff collection system 108 is most likely to secure them and where the air current into the hood 110 is strongest.

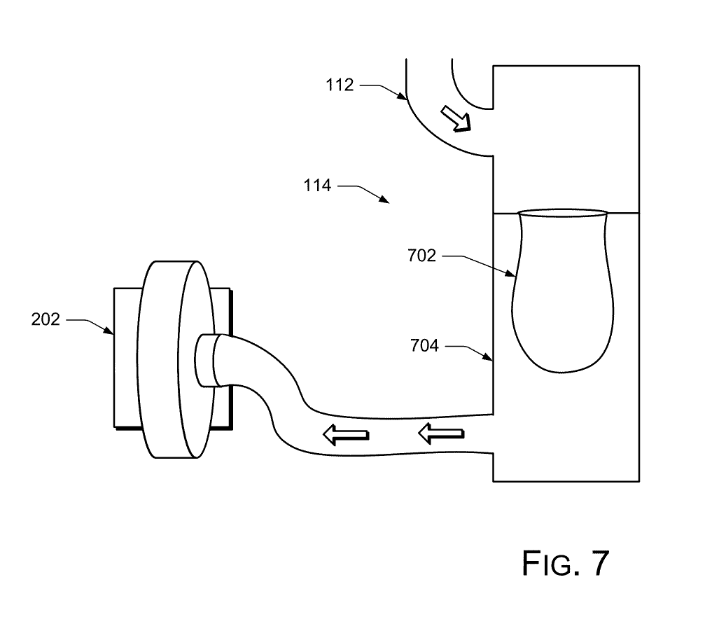

FIG. 7 shows an example electrostatic collector 114 of the chaff collection system 108. In an implementation, the electrostatic collector 114 can be a flat filter or a bag filter, with or without electronic air cleaning elements. In an implementation, a gas-permeable bag 702 is secured within a chaff collection chamber 704. All the air, chaff, smoke particulates, and gases collected by the hood 110 must pass through the permeable bag 702. Suction for this process is provided by the vacuum assembly 202.

A non-electrified version of an electrostatic collector 114 consists of a fiber filter bag 702, composed of nylon, for example, or an aliphatic polyamide, a polypropylene, a polyurethane, a thermoplastic, or other strong permeable material that can collect a static or an electrostatic charge of opposite polarity to a charge induced on the chaff and smoke particulates. In an implementation, airflow through the electrostatic collector 114 charges the fibers or mesh of the permeable filter bag 702 through the triboelectric effect to attract the chaff pieces and the smoke particulates to the charged mesh or fibers. In another or the same implementation, the permeable filter bag 702 has two layers and is an electrostatic filter per se.

In an implementation, the vacuum assembly 202 creates an airflow velocity through the mesh or fibers of the electrostatic collector 114 sufficient to charge the mesh or fibers of the electrostatic collector 114 (e.g., bag) with a first electrostatic polarity and sufficient to charge the chaff pieces and the smoke particulates to a second electrostatic polarity, so that the mesh or fibers of the electrostatic collector 114 loosely attract the chaff pieces and the smoke particulates, but the chaff and smoke particulates (of same charge) repel each other to help resist a clogging of the mesh or fibers, instead of the chaff and smoke particulates binding tightly and irreversibly to the fibers (although reversible by standard cleaning of such a mesh or fiber filter).

In an implementation, air flows over a circular rim of a mesh nylon filter bag 702 in the electrostatic collector 114 at an angle that creates a cyclonic action creating an electrostatic charge or static charge on the mesh nylon filter bag 702. The airflow continues on through the mesh nylon filter bag 702 leaving behind chaff and smoke particulates, and is then vented externally from the example bean roaster 100.

In an implementation, the filter bag 702 is made of nylon with a service rating of 350 degrees F with 200 micron filtration. As the air passes through the nylon bag 702 a static charge is created which prevents the chaff from sticking to the bag. This allows the bag 702 to fill up to half full before emptying is desirable. The bag 702 can also be selected to filter the oils from the roast smoke, which prevents buildup of oily residue in the exhaust system. Such a nylon filter bag 702 can be washed with soap and water and re-used.

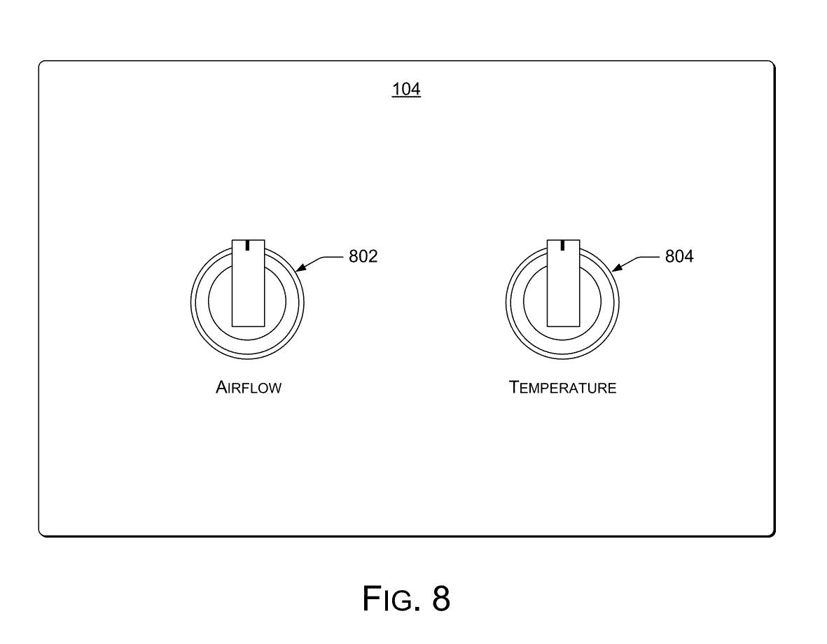

FIG. 8 shows the example control panel 104 of FIG. 1, in greater detail. In an implementation, the example control panel 104 has an airflow controller 802 and a temperature controller 804. Both of these controllers 802 & 804 provide variable control of their components across a smooth continuum. Airflow controller 802 may vary the pressure and volume of the heated airflow, under one knob, dial, slider, icon, etc. Likewise, temperature controller 804 gives the user control of the temperature of the fluid bed for roasting beans in a smooth continuum from zero to a maximum, for example from 1100 watts to 10,400 watts, yielding a maximum temperature of perhaps 450 degrees Fahrenheit or more in the roasting hopper 106.

Although relatively simple, the example control panel 104 of FIG. 8 with controls having infinite variability within a range, affords the user the ability to roast a very small batch of beans, e.g., one-eighth pound (or just a few ounces), or, a batch sized to the maximum capacity of the example bean roaster 100—in one implementation, about ten pounds.

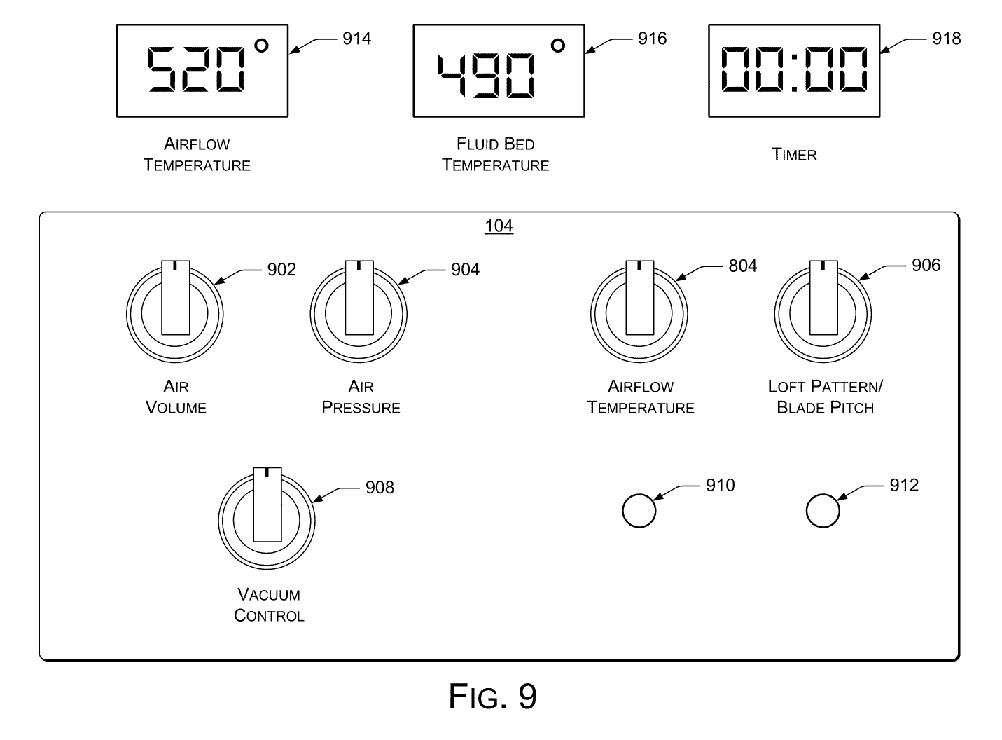

FIG. 9 shows another example control panel 104, having additional controls, gauges, meters, and indicator lights. It is worth noting that the example control panel 104, in some implementations, may be embodied on a computer display, tablet screen, iPad, mobile phone, and so forth, as visual icons, yet affording the same control via digital communications, and/or network and Internet.

In the example control panel 104 of FIG. 9, the functionality of the airflow controller 802 of FIG. 8 is split into a separate air volume variable controller 902 and a separate air pressure variable controller 904. This may assume a more sophisticated blower 302 or other air source, wherein air volume and air pressure are separately addressable by the controllers 902 & 904. The airflow temperature controller 804 remains variable across a continuum of temperatures. An optional loft pattern or diffuser blade pitch controller 906 may also be provided.

Other optional features and indicators of the example control panel of FIG. 9 may include a separate vacuum controller 908 for controlling the degree of suction at the hood 110, e.g., to match an airflow volume exiting the hopper 106, and/or to charge the electrostatic filter 702 in a certain manner with a specific airflow velocity. One or more indicator lights 910 & 912 may indicate power on, or “finished roast,” or a machine fault.

The example control panel 104 may also include meters, gauges, and readouts. For example, airflow temperature 914 may be displayed as measured by thermometer 312, fluid bed temperature 916 as measured by thermometer 314, and other parameters may be displayed, such as current air volume in the heated airflow; air pressure in the heated airflow; diffuser blade pitch, vacuum airflow in the chaff collection system 108, etc. The example control panel 104 may also include one or more timers 918, for timing a bean roast, including countdown timers and time-elapsed timers. In an implementation, the example bean roaster displays the weight of beans in the hopper 106.

Representative Process

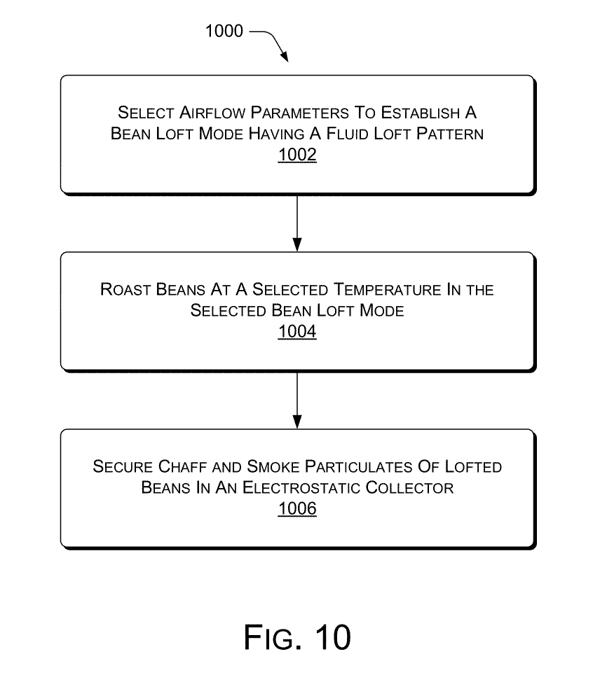

FIG. 10 illustrates a representative process 1000 for roasting beans. The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable materials, or combinations thereof, without departing from the scope of the subject matter described herein.

At block 1002, the process includes selecting airflow parameters to establish a bean loft mode that has a fluid loft pattern. The parameters of airflow, including air volume and air pressure may be user selected along a continuous range. The selected airflow interacts with a diffuser to create airflow streams in the roast hopper, which in turn interact with the geometry of the roast hopper itself and the beans, including their size, mass, number, and streamline properties, to create a fluid loft pattern, such as helical patterns or spray patterns. These in turn provide roasting advantages over conventional fluid bed roasting techniques.

At block 1004, beans are roasted at a selected temperature, at the selected bean loft mode. The bean loft mode includes the airflow parameters selected by the user and the resulting fluid loft pattern. Temperature may be selected within a continuous range for a custom roast. The temperature selection may also be customized for the amount of beans present, ranging from only a few ounces, to man pounds.

At block 1006, chaff and smoke particulates of the lofted beans are secured in an electrostatic collector, during the roast. By running air through a mesh filter, the mesh can be statically charged to attract the chaff and smoke constituents, and the chaff and smoke particles take on the opposite charge to repel each other. This is useful in a bag filter, where the collected particles do not mat to each other, but instead allow air to pass through the filter and contents until there is considerable chaff collected.

Conclusion

Although only a few example embodiments have been described in detail above, those skilled in the art will readily appreciate that many modifications are possible in the example embodiments without materially departing from a deployment and retrieval system. Accordingly, all such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 U.S.C. §112 (f) for any limitations of any of the claims herein, except for those in which the claim expressly uses the words ‘means for’ together with an associated function.

1. A system, comprising:
a hopper for containing a fluid loft for roasting beans;
a diffuser for redirecting a heated airflow into a base of the hopper to create a helical flow for the fluid loft;
a vacuum assembly having a hood for receiving airborne chaff pieces and smoke particulates from the hopper; and
an electrostatic collector for securing the chaff pieces and the smoke particulates using at least in part a static charge.

2. The system of claim 1, wherein the helical flow comprises a lofted bean trajectory and a heated airflow trajectory; and
further comprising a first controller to continuously vary a degree of a lift force of the heated airflow from zero to a maximum and to continuously vary a degree of a pitch of the helical flow in relation to the lift force.

3. The system of claim 2, wherein the first controller enables a user to dynamically change a stream shape of the heated airflow and to control a flow shape of the lofted bean trajectory during roasting.

4. The system of claim 2, wherein the helical flow increases a path length of the lofted bean trajectory and rolls the lofted beans to increase an exposure of the lofted beans to the heated airflow;
wherein the lofted bean trajectory dynamically changes based on a changing average mass of each bean from a chaff loss and an oil loss during roasting; and
wherein the lofted bean trajectory increases a bean travel time and a bean motion, for chaff removal.

5. The system of claim 4, wherein the hopper has at least a conical section for widening the helical flow of the lofted bean trajectory to increase a circular speed and centrifugal force on the lofted beans; and
wherein the lofted beans at a high circular speed contact a laminar flow of the heated airflow at an inside surface of the conical section.

6. The system of claim 2, wherein the first controller enables a user to vary an airflow volume and an airflow pressure of the heated airflow along a continuum from zero airflow volume and zero airflow pressure to approximately 160 cubic feet per minute volume at a pressure of approximately 110 Torr.

7. The system of claim 2, further comprising a second controller to vary a temperature of the heated airflow along a continuum from approximately 0 degrees Fahrenheit to approximately 560 degrees Fahrenheit.

8. The system of claim 7, wherein the first controller and the second controller enable a variable pitch of the helical airflow and enable a variable volume, a variable pressure, and a variable temperature of the heated airflow to provide a controlled roast to between approximately one-eighth pound and approximately nine pounds of the beans.

9. The system of claim 8, wherein the beans comprise one of coffee beans or cocoa beans.

10. The system of claim 1, wherein the diffuser comprises multiple blades, each blade having an airstream taper and each blade disposed at a pitch in relation to an axial flow of the heated airflow entering the diffuser.

11. The system of claim 10, wherein each blade is nominally disposed at a 37 degree pitch in relation to an axial flow of the heated airflow entering the diffuser.

12. The system of claim 10, further comprising an axial diffusion slot in each blade to pass a portion of the heated airstream axially though each blade in relation to the helical flow.

13. The system of claim 10, further comprising a third controller to vary the pitch of the multiple blades of the diffuser to control a degree of a pitch of the helical flow.

14. The system of claim 1, further comprising:
a first controller to continuously vary a degree of a lift force of the heated airflow;
a second controller to vary a temperature of the heated airflow along a continuum from 0 degrees Fahrenheit to approximately 550 degrees Fahrenheit;
wherein the first controller, the second controller, and the third controller to vary the pitch of the multiple blades of the diffuser are adjustable to establish multiple bean loft modes, including:
a helical bean loft mode characterized by the lofted beans moving in one or more helical paths or patterns;
a fountain spray bean loft mode characterized by the lofted beans moving in a spray pattern, wherein the lofted beans rise vertically from an inner radius of the hopper and fall at an outer radius of the hopper, while the heated airflow stirs the fluid loft and the lofted beans; and
a combination mode including both the helical bean loft mode and the fountain spray mode in a resonance pattern with the cylindrical geometry of the hopper.

15. The system of claim 1, wherein the electrostatic collector comprises one of a flat filter or a bag filter.

16. The system of claim 1, wherein the electrostatic collector comprises fibers composed of one of a nylon, an aliphatic polyamide, a polypropylene, a polyurethane, or a thermoplastic.

17. The system of claim 16, wherein an airflow through the electrostatic collector charges the fibers of the electrostatic collector to attract the chaff pieces and the smoke particulates to the fibers.

18. The system of claim 16, wherein the vacuum assembly creates an airflow through the fibers of the electrostatic collector at a velocity sufficient to charge the fibers with a first electrostatic polarity and to charge the chaff pieces and the smoke particulates to a second electrostatic polarity; and
wherein the fibers attract the chaff pieces and the smoke particulates while the chaff pieces repel each other and the smoke particulates repel each other to resist a clogging of the fibers of the electrostatic collector.

19. A bean roaster, comprising:
a roasting assembly miniaturized by condensing a first airflow path of an airflow for roasting beans and a second airflow path of an airflow for collecting chaff from the beans;
a cyclonic diffuser to increase a loft path and a loft duration of the beans within a limited volume of a hopper of the roasting assembly; and
an electrostatic chaff collector to secure the chaff within a limited length of the second airflow path of the airflow for collecting the chaff.

20. The bean roaster of claim 19, wherein a volume, a pressure, and a temperature of the airflow for roasting the beans are each continuously adjustable from a zero value to a maximum value, to roast a mass of the beans ranging from approximately one-eighth pound to approximately nine pounds.
